(19) United States
(12) Patent Application Publication
(10) Pub. No.: US 2009/0047464 A1
(43) Pub. Date: Feb. 19, 2009

(54) FLOOR CARPET UNDERLAY

(76) Inventors: David G. Foxall, Brantford (CA); Joseph M. Gallant, Brantford (CA); Jitesh B. Patel, Brantford (CA)

Correspondence Address: MANELLI DENISON & SELTER, 2000 M STREET NW SUITE 700, WASHINGTON, DC, 20036-3307, US

(21) Appl. No.: 11/839,725

(22) Filed: Aug. 16, 2007

(51) Int. Cl. B32B 3/26; B29C 65/00; D05C 15/00

(52) U.S. Cl. 428/95; 156/72; 425/224

(57) ABSTRACT

A carpet underlay for a floor carpet, the underlay having a foam base layer having an upper surface, and a cross-linked closed cell polyolefin foam upper layer having a first surface and a second surface, wherein the first surface is bonded to the upper surface of the base layer and the second surface is adapted to contact the carpet in abutment. Preferred foam base layer comprises a polyurethane foam, particularly, chipfoam; and the cross-linked closed cell foam layer comprises polyethylene, polyolefine, polyamide and mixtures, thereof. Apparatus and process of manufacture are provided. The underlay provides improved resistance to odour and toxic vapour penetration from the base foam layer through the carpet into the atmosphere above the carpet.

### FIELD OF THE INVENTION

This invention relates to underlay for floor carpets, particularly foam based underlay, process of manufacture, thereof, and apparatus for use in said process.

### BACKGROUND OF THE INVENTION

Typical underlay or underpads for floor carpets is formed of a foam material, particularly, a polyurethane foam, either as virgin material, or as reclaimed and recycled material. The latter material is generally termed “chipfoam” and comprises small pieces or fragments of a plurality of used polyurethane foams of different sizes, shapes, densities and weights, and often containing pieces of harder materials, such as plastic materials. The underlay generally comes in about 13.7 m rolls having a width of about 1.83 m, a typical thickness of about 6.5-13 mm, and a density of about 3.5-10 tbs/cu. ft.

Although polyurethane chipfoam has been extensively used for a long time as underlay for floor carpets in residential, commercial and industrial buildings, it is prone to release gaseous toxic chemicals into the atmosphere of a room or the like through the carpet which rests on the underlay, to varying degrees from the date of its installation and continually over the life of the underfoam. Examples of such unwanted chemicals includes, formaldehyde, ammonia, hydrochloric acid and, particularly, butylated hydroxy toluene (BHT).

Production of these and more dangerous gaseous toxic chemicals, including carcinogens is enhanced in the event of a fire. To reduce the risk or likelihood of the foam burning, a fire retardant is commonly present.

Chipfoam further comprising a plastic film layer on the upper side face of the chipfoam, which contacts the bottom surface of the carpet, is also known and commercially available. The plastic layer is intended to provide a moisture barrier if a liquid spill penetrates the carpet backing.

Further, anti-microbial agents for microbe control and odour-treating agents to eliminate organic odours, which may emanate from the foam have been incorporated into the foam.

However, there is still a long-felt want to have a foam underlay which minimizes the release of the aforesaid toxic gaseous chemicals into the atmosphere of a room, or the like, through the carpet above the underlay and provide an improved moisture barrier.

The use of cross-linked closed cell polyolefin foams as sound insulation material in flooring systems has been described in Canadian Patent No. 2,454,972, issued 22 May 2007 to F. C. & F.

### SUMMARY OF THE INVENTION

It is an object of the present invention to provide a foam underlay for floor carpeting having an improved moisture resistant and gaseous toxic chemical imperious barrier.

It is a further object to provide a process and apparatus for the manufacture of said improved underlay.

Accordingly, in one aspect the invention provides a carpet underlay for a floor carpet, said underlay comprising
a foam base layer having an upper surface, and
a cross-linked closed cell polyolefin foam upper layer having a first surface and a second surface, wherein said first surface is bonded to said upper surface of said base layer and said second surface is adapted to contact said carpet in abutment.

Preferably, the base layer comprises a polyurethane foam; preferably having a thickness selected from 5.0 mm to 2.0 cm, and, more preferably, selected from 6.5 mm to 1.4 cm.

The polyolefin foam preferably comprises a cross-linked, closed-cell polyethylene, polypropylene or polyamide, or blends, thereof. Examples of such foams are manufactured by Toray Plastics (America), Inc., and Sekisui Voltek LLC, a division of Sekisui America Corp. Other suitable examples of closed cell polyolefin foams will be appreciated by those skilled in the art.

The polyolefin foam upper layer preferably has a thickness selected from 0.5 mm to 2.5 mm, and more preferably, 0.65 mm to 2.0 mm.

We have found that when the thickness of the cross-linked closed cell polyolefin foam layer is preferably not less than 0.5 mm, it smoothes out irregularities in the base foam layer caused by particles of different sizes, shapes and materials, particularly when the latter is a plastics material. This results in less abrasion of the underside of the carpet.

In preferred embodiments, either or both of the layers contain fire-retardant, anti-microbial and odour absorbing chemicals.

In a further aspect, the invention provides a process for the manufacture of an underlay as hereinabove defined.

Accordingly, in a further aspect the invention provides a process of forming a carpet underlay comprising
a foam base layer having an upper surface, and
a cross-linked closed cell polyolefin foam upper layer having a first surface and a second surface, wherein said first surface is bonded to said upper surface of said base layer and said second surface is adapted to contact said carpet in abutment;
said process comprising continuously bringing a foam base layer and a cross-linked closed cell polyolefin foam layer into contact, wherein said upper surface of said foam base layer contacts said first surface of said polyolefin foam layer;
heat treating said layers to effect bonding to produce said underlay, and collecting said underlay.

We have noticed that heat treatment of the polyolefin foam layer to the softening temperature of the foam, per se, causes expansion of the foam, while subsequent cooling of the foam effects contraction to its original dimensions. However, we have found that when the polyolefin foam layer and the base layer are heat treated to their softening temperatures for bonding, one to the other, for unnecessary, relatively long periods of time, the polyolefin foam layer is unable to satisfactorily contract and its upper surface becomes rippled. Without being bound by theory, we believe that this is a result of overheating because the feed rate of the two layers is too slow and/or the heating temperature is too high and, thus, effecting too much heat transfer.

Thus, while the process of the invention requires both layer foam materials to become soft and tacky for effective bonding, the heat transfer most preferably, should not be excessive as to cause the aforesaid rippling of the polyolefin layer. The presence of the ripples on the upper surface of the underlay presents a problem to the carpet installer and uneven surface contact with the carpet.

Accordingly, in a further aspect the invention provides a process as hereinabove defined wherein said foam base layer and said polyolefin foam layer are suitably heat treated at a temperature and feed rate as to effect bonding without the production of excessive amounts of ripples on said second surface of said polyolefin foam. A feed rate of at least 10 m per minute at an effective softening temperature is preferred.

In a further aspect, the invention provides apparatus for carrying out the process for the manufacture of an underlay as hereinabove defined.

Accordingly, the invention provides apparatus for manufacturing a carpet underlay comprising
a foam base layer having an upper surface, and
a cross-linked closed cell polyolefin foam upper layer having a first surface and a second surface, wherein said first surface is bonded to said upper surface of said base layer and said second surface is adapted to contact said carpet in abutment,
said apparatus comprising
   (i) heating and pressure contacting means for effecting bonding of said foam base layer to said cross-linked closed cell polyolefin foam to form said underlay;
   (ii) means for feeding a roll of said foam base layer to said heating and pressure contacting means;
   (iii) means for feeding a roll of said polyolefin foam layer to said heating and pressure contacting means; and
   (iv) means for collecting said underlay.

### BRIEF DESCRIPTION OF THE DRAWINGS

In order that the invention may be better understood, preferred embodiments will now be described, by way of example only with reference to the drawings, wherein

FIG. 1 is a diagrammatic cross-section of a carpet underlay, according to the invention, in associate with a carpet; and

FIG. 2 is a diagrammatic block diagram of the apparatus of use in the manufacture of an underlay, according to the invention; and wherein the same numerals denote like parts.

### DETAILED DESCRIPTION OF PREFERRED EMBODIMENTS

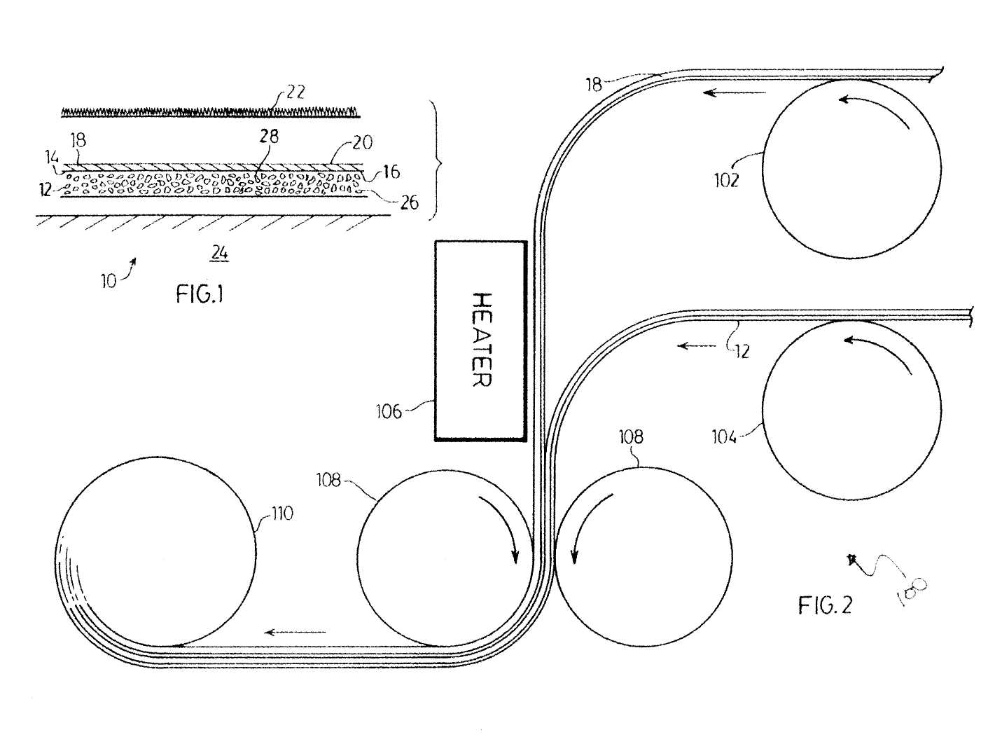

With reference to FIG. 1, this shows generally as 10, an underlay having a chipfoam polyurethane foam base layer 12 having an upper surface 14 bonded to the lower surface 16 of a cross-linked closed cell polyethylene layer 18. Layer 18 has an upper surface 20 upon which carpet 22 contacts and abuts upon installation on floor 24. Base layer 12 has a thickness of about 6.5 mm and polyethylene layer 18 has a thickness of about 0.8 mm. Chipfoam base layer 12 comprises a mixture of polyurethane particles 26, interspaced with hard fragments of plastics materials 28. Layers 12 and 18 have been bonded together by heat treatment, as hereinafter described.

In alternative embodiments, an adhesive is used to effect bonding of layers 12 and 18. The underlay 10 may be manufactured in any suitable length and width as desired and rolled for transportation and subsequent handling by a carpet installer.

With reference to FIG. 2, this shows generally as 100, apparatus and process for manufacturing underlay 10 from individual rolls of polyurethane base layer 12 and cross-linked closed cell polyethylene layer 18.

Apparatus 100 has polyethylene foam feed rollers 102, polyurethane chipfoam rollers 104 forwarding polyolefin foam layer 18 having a thickness of 0.8 mm and polyurethane layer 12, respectively, past heater 106 to soften both materials which are pulled into abutment under contact pressure and bonded by rolls 108 at a feed rate of about 20 m per minute. Underlay product 10 is optionally cooled and collected on roll 110.

Although this disclosure has described and illustrated certain preferred embodiments of the invention, it is to be understood that the invention is not restricted to those particular embodiments. Rather, the invention includes all embodiments, which are functional or mechanical equivalence of the specific embodiments and features that have been described and illustrated.

1. A carpet underlay for a floor carpet, said underlay comprising
a foam base layer having an upper surface, and
a cross-linked closed cell polyolefin foam upper layer having a first surface and a second surface, wherein said first surface is bonded to said upper surface of said base layer and said second surface is adapted to contact said carpet in abutment.

2. An underlay as claimed in claim 1 wherein said foam base layer comprises polyurethane foam.

3. An underlay as claimed in claim 1 wherein said base layer has a thickness selected from 5.0 mm to 2.0 cm.

4. An underlay as claimed in claim 3, wherein said base layer has a thickness selected from 6.5 mm to 1.4 cm.

5. An underlay as claimed in claim 1 wherein said polyolefin foam comprises cross-linked closed cell polyethylene foam.

6. An underlay as claimed in claim 1 wherein said polyolefin foam comprises cross-linked closed cell polypropylene foam.

7. An underlay as claimed in claim 1 wherein said polyolefin foam comprises cross-linked closed cell polyamide foam.

8. An underlay as claimed in claim 1 wherein said polyolefin foam upper layer has a thickness selected from 0.5 mm to 2.5 mm.

9. An underlay as claimed in claim 8 wherein said polyolefin foam upper layer has a thickness selected from 0.65 mm to 2.0 mm.

10. A process of forming a carpet underlay comprising
a foam base layer having an upper surface, and
a cross-linked closed cell polyolefin foam upper layer having a first surface and a second surface, wherein said first surface is bonded to said upper surface of said base layer and said second surface is adapted to contact said carpet in abutment;
said process comprising continuously bringing a foam base layer and a cross-linked closed cell polyolefin foam layer into contact, one to the other, wherein said upper surface of said foam base layer contacts said first surface of said polyolefin foam layer;
heat treating said layers to effect bonding to produce said underlay, and collecting said underlay.

11. A process as claimed in claim 10 wherein said foam base layer and said cross-linked closed cell polyolefin foam layer are suitably heat treated at a temperature and feed rate as to effect said bonding without the production of excessive amounts of ripples on said second surface of said polyolefin foam.

12. A process as claimed in claim 11, comprising bringing said foam base layer and said polyolefin foam layer into contact at a feed rate of at least 10 m per minute at an effective softening and bonding temperature of said layers.

13. Apparatus for manufacturing a carpet underlay comprising a foam base layer having an upper surface, and
a cross-linked closed cell polyolefin foam upper layer having a first surface and a second surface, wherein said first surface is bonded to said upper surface of said base layer and said second surface is adapted to contact said carpet in abutment,
said apparatus comprising
(i) heating and pressure contacting means for effecting bonding of said foam base layer to said cross-linked closed cell polyolefin foam to form said underlay;
(ii) means for feeding a roll of said foam base layer to said heating and pressure contacting means;
(iii) means for feeding a roll of said polyolefin foam layer to said heating and pressure contacting means; and
(iv) means for collecting said underlay.
